(19) United States
(12) Patent Application Publication
(10) Pub. No.: US 2024/0344489 A1
(43) Pub. Date: Oct. 17, 2024

(54) FUEL INJECTOR FOR GASEOUS FUEL AND VALVE ASSEMBLY FOR THE SAME

(71) Applicant: Cummins Inc., Columbus, IN (US)

(72) Inventors: Raymond V. Primus, Bargersville, IN (US); Ross A. Phillips, Columbus, IN (US); Anthony Allan Shaull, Columbus, IN (US); Andrew Jacob Laska, Columbus, IN (US)

(21) Appl. No.: 18/604,838

(22) Filed: Mar. 14, 2024

Related U.S. Application Data
(60) Provisional application No. 63/496,541, filed on Apr. 17, 2023.

(51) Int. Cl. F02M 21/02

(52) U.S. Cl. CPC F02M 21/0275; F02M 21/0254; F02M 21/0257

(57) ABSTRACT

A fuel injector for gaseous fuel is provided. The fuel injector includes a valve assembly with a first valve and a second valve. The first valve is actively controlled to permit and prohibit gaseous fuel flow through the first injector. The second valve is spaced from the first valve and passively controlled to open in response to the gaseous fuel flow though the first valve, and to close when the gaseous fuel flow is terminated by closing the first valve.

### CROSS-REFERENCE TO RELATED APPLICATION

The present application claims the benefit of the filing date of U.S. Provisional Application Ser. No. 63/496,541 filed Apr. 17, 2023, which is incorporated herein by reference.

### FIELD OF THE DISCLOSURE

The present disclosure relates generally to a fuel injector for providing gaseous fuel for an internal combustion engine and, more particularly, to a valve assembly arrangement for a fuel injector for gaseous fuel.

### BACKGROUND

Fuel injectors for gaseous fuel injection are subject to extreme conditions due to pressure and temperature. When combustion of the gaseous fuel occurs in the combustion chamber, high temperature combustion gases can flow back into the fuel injector, causing a rapid change in temperature and applied force to the injector components. The potential for wide variations in temperature and pressure conditions within the fuel injector can reduce fuel injector life and robustness. Therefore, there remains a need for the unique apparatuses, systems, and techniques disclosed herein.

### DISCLOSURE OF ILLUSTRATIVE EMBODIMENTS

For the purposes of clearly, concisely and exactly describing illustrative embodiments of the present disclosure, the manner, and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created and that the invention includes and protects such alterations, modifications, and further applications of the exemplary embodiments as would occur to one skilled in the art.

### SUMMARY

The present disclosure includes a valve assembly for a fuel injector of a gaseous fuel injection system for an internal combustion engine. The valve assembly includes a first valve to control the flow of gaseous fuel into the fuel injector, and a second valve spaced longitudinally from the first valve to control the flow of combustion gases from the combustion chamber back into the fuel injector. The ability to control the flow of gaseous fuel from the injector and the flow of combustion gases back into the fuel injector reduces exposure of fuel injector components to temperature changes, improves fuel injector robustness, and increases operating life.

In an embodiment, a fuel injector for providing gaseous fuel to a combustion chamber is provided. The fuel injector includes an elongated injector body defining a longitudinally extending fuel passage therein. The fuel passage extends from a gas inlet end to a gas outlet end of the body. Fuel injector includes a valve assembly in the fuel passage. The valve assembly includes a first valve that is selectively opened and closed to control gaseous fuel flow through the fuel passage to the combustion chamber. The valve assembly also includes a second valve configured to control combustion gas flow from the combustion chamber into the fuel passage through the gas outlet end. The second valve is spaced longitudinally from the first valve toward the gas outlet end. The second valve is biased to a closed position, and the second valve is moved from the closed position to an open position by the gaseous fuel flow through the opened first valve.

In an embodiment, a valve assembly in an axially extending gaseous fuel passage of a fuel injector for providing gaseous fuel to a combustion chamber is provided. The valve assembly includes first valve in the gaseous fuel passage. The first valve includes a first valve seat and a first plunger, and the first plunger is actuatable between an open position in which the first plunger is axially spaced from the first valve seat and a closed position in which the first plunger is in sealing contact with the first valve seat. Valve assembly also includes second valve in the gaseous fuel passage axially spaced from the first valve along the gaseous fuel passage. The second valve includes a second valve seat and a second plunger biased into engagement with the second valve seat. The second plunger is disengaged from the second valve seat by gaseous fuel flow through the first valve when the first valve is in the open position.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like numerals refer to like parts throughout the several views, and wherein:

FIG. 1 is a schematic view of a fuel injection system.

FIG. 2 is a longitudinal section view illustrating an example fuel injector for an internal combustion engine, according to an embodiment of the present disclosure.

FIG. 3 is an enlarged longitudinal section view of the valve assembly of the fuel injector of FIG. 2.

FIG. 4 is an exploded view of the fuel injector of FIG. 2.

FIG. 5 is an enlarged longitudinal section view of the first valve of the valve assembly of FIG. 3 in a closed position.

FIG. 6 is an enlarged longitudinal section view of the second valve of the valve assembly of FIG. 3 in a closed position.

FIG. 7 is an enlarged longitudinal section view of the first valve of the valve assembly of FIG. 3 in an open position.

FIG. 8 is an enlarged longitudinal section view of the second valve of the valve assembly of FIG. 3 in a closed position.

### DETAILED DESCRIPTION OF ILLUSTRATIVE EMBODIMENTS

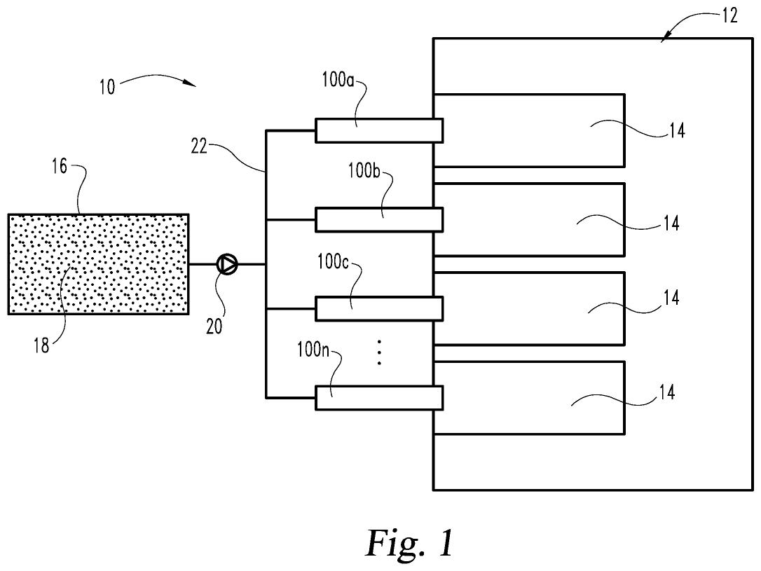

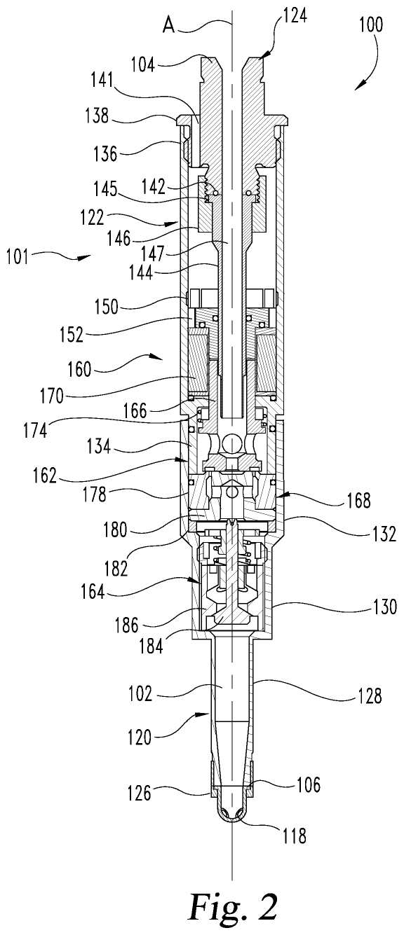

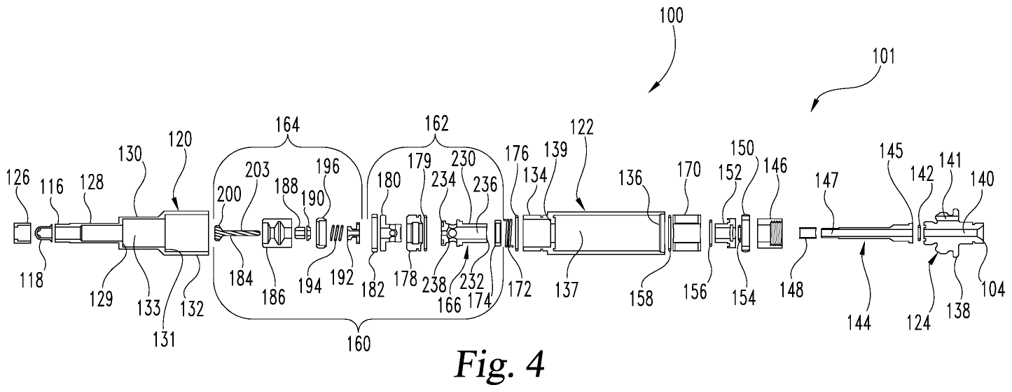

With reference to FIG. 1, there is illustrated a fuel injection system 10 including at least one fuel injector 100a, 100b, 100c . . . 100n for a respective combustion chamber 14 of an internal combustion engine 12. The at least one fuel injector 100a, 100b, 100c . . . 100n is in fluid communication with a fuel source 16 containing a gaseous fuel 18, and a fuel tank/regulator 20 and/or common rail 22 to distribute fuel to the injectors 100a, 100b, 100c . . . 100n. Although multiple fuel injectors are shown schematically in FIG. 1, system 10 may include any number of fuel injectors, including one fuel injector. Pressurized gaseous fuel 18 is supplied to each of the fuel injectors 100a, 100b, 100c . . . 100n from the fuel tank/regulator 20. In the discussion that follows, fuel injectors 100a, 100b, 100c . . . 100n are described with reference to a fuel injector 100, such as shown in FIGS. 2-8.

In an embodiment, the fuel injector 100 provides gaseous fuel to combustion chamber 14. The fuel injector 100 includes an elongated injector body 101 defining a longitudinally extending fuel passage 102 therein. The fuel passage 102 extends from a gas inlet end 104 to a gas outlet end 106 of the body 101. Fuel injector 100 includes a valve assembly 160 in the fuel passage 102. The valve assembly 160 includes a first valve 162 that is selectively opened and closed to control gaseous fuel flow through the fuel passage 102 to the combustion chamber 14. The valve assembly 160 also includes a second valve 164 configured to control combustion gas flow from the combustion chamber 14 into the fuel passage 102 through the gas outlet end 106. The second valve 164 is spaced longitudinally from the first valve 162 toward the gas outlet end 106. The second valve 164 is biased to a closed position, and the second valve 164 is moved from the closed position to an open position by the gaseous fuel flow through the opened first valve 162.

In an embodiment, valve assembly 160 is provided in the axially extending gaseous fuel passage 102 of fuel injector 100 to provide gaseous fuel to combustion chamber 14. The valve assembly 160 includes first valve 162 in the gaseous fuel passage 102. The first valve 162 includes a first valve seat 168 and a first plunger 166, and the first plunger 166 is actuatable between an open position in which the first plunger 166 is axially spaced from the first valve seat 168 and a closed position in which the first plunger 166 is in sealing contact with the first valve seat 168. Valve assembly 160 also includes second valve 164 in the gaseous fuel passage 102 axially spaced from the first valve 162 along the gaseous fuel passage 102. The second valve 164 includes a second valve seat 186 and a second plunger 184 biased into engagement with the second valve seat 186. The second plunger 184 is disengaged from the second valve seat 186 by gaseous fuel flow through the first valve 162 when the first valve 162 is in the open position.

Referring to FIGS. 2-4, injector body 101 extends along a central longitudinal axis A and includes fuel passage 102 that is defined by the injector body 101 from gas inlet end 104 to gas outlet end 106. The longitudinally extending fuel passage 102 receives valve assembly 160 and a valve actuator 170 therein to control gaseous fuel flow from gas inlet end 104 to gas outlet end 106, and to control combustion gas flow from gas outlet end 106 into fuel passage 102. In the discussion that follows, “proximal” or “proximally” refer to an axial location or upstream direction toward gas inlet end 104, and “distal” or “distally” refers to an axial location or downstream direction toward gas outlet end 106.

Injector body 101 can be comprised of multiple parts that are coupled to one another to form injector body 101. In the illustrated embodiment, injector body 101 includes an outlet part 120 extending from gas outlet end 106, an inlet part 124 extending from gas inlet end 104, and a transition part 122 that connects outlet part 120 and inlet part 124. Other embodiments contemplate an injector body 101 made from a single body part, from two body parts, or from more than two body parts.

Inlet part 124 includes a flange 138 to facilitate mounting of the fuel injector 100 on the engine 12. A feature may also be provided on the injector body 101 to facilitate injector mounting. Inlet part 124 also includes a gas passage 140 for receiving gaseous fuel flow into passage 102 of injector body 101. Inlet part 124 may also include a bore 141 for receiving wires (not shown) that are coupled to valve actuator 170.

A nozzle 118 is engaged to the end of outlet part 120 with a nozzle coupler 126. In other embodiments, a nozzle coupler 126 is not provided. Nozzle 118 may include one or more holes arranged to divert gaseous fuel flow in a desired direction or flow pattern into the combustion chamber 14. Nozzle 118 can be configured to optimize combustion of the gaseous fuel based on the combustion conditions of engine 12. Nozzle 118 is always open to allow the gaseous fuel flow to exit fuel passage 102, which also allows combustion gases to enter fuel passage 102.

In the illustrated embodiment, the outlet part 120 includes an interior 133 with three stepped regions 128, 130, 132. First stepped region 128 is adjacent to gas outlet end 106 and is coupled to nozzle 118. First stepped region 128 is smallest in diameter, and receives gaseous fuel flow from the opened second valve 164. In addition, combustion gases enter first stepped region 128 from the combustion chamber 14, as discussed further below.

Second valve 164 is housed primarily in second stepped region 130, and first valve 162 is partially housed in third stepped region 132. Transition part 122 is also engaged to third stepped region 132. In the illustrated embodiment, transition part 122 includes an insert region 134 that is positioned within and engaged to third stepped region 132, such as by a threaded, welded, press-fit, or other suitable engagement. The connection between outlet part 120 and transition part 122 is sealed with injector body seal 176. Injector body seal 176, and the other seals mentioned herein, can be circular or annular rings made from elastomeric material or other suitable configuration and/or material. Transition part 122 also includes a receiving region 136 that receives and engages the inlet part 124, such as by a threaded, welded, press-fit, or other suitable engagement. Flange 138 of inlet part 124 can abut the outer proximal end of transition part 122 at receiving region 136.

Fuel injector 100 includes a tube 144 that is located in interior 137 of transition part 122. Tube 144 is engaged end-to-end with inlet part 124 with a tube coupler 146. Any type of coupling device for tube coupler 146 is contemplated. In the illustrated embodiment, tube coupler 146 includes internal threads to threadingly engage corresponding threads on inlet part 124, and an internal collar to support a flanged proximal end 145 of tube 144. As a result, tube 144 is axially fixed in body 101. An end seal 142 can be provided in a groove in the end face of inlet part 124 that seals against the abutting end of tube 144. Tube 144 includes a bore 147 that defines a part of fuel passage 102 from inlet part 124 to valve assembly 160.

Actuator 170 is also located in interior 137 of transition part 122. Actuator 170 controls the opening of the gaseous fuel flow valve, designated as first valve 162. In an embodiment, actuator 170 is an electronic actuator, such as a solenoid, that is electronically controlled by energizing and de-energizing a magnetic coil to actively and selectively control opening and closing for first valve 162 of valve assembly 160. An actuator retainer 150 is secured to the inner wall of transition part 122, and an actuator mount 152 is positioned between actuator 170 and actuator retainer 150. Tube 144 extends though actuator mount 152 and actuator 170. A first mount seal 154 seals the connection between tube 144 and actuator mount 152, and a second mount seal 156 seals the connection between actuator mount 152 and actuator 170. An actuator seal 158 seals the connection between actuator 170 and the interior 137 of transition part 122 at insert region 134.

First plunger 166 extends into interior 137 of transition part 122 and around the end of tube 144. First plunger 166 is engaged to, and axially movable toward gas inlet end 104, by actuation of actuator 170. In an embodiment, first plunger 166 is an armature plunger. In an embodiment, first plunger 166 is comprised entirely of the same material. A plunger guide 148 is provided between tube 144 and first plunger 166 that helps guide between first plunger 166 and tube 144, but allows first plunger 166 to axially translate along tube 144 in response to actuation by actuator 170.

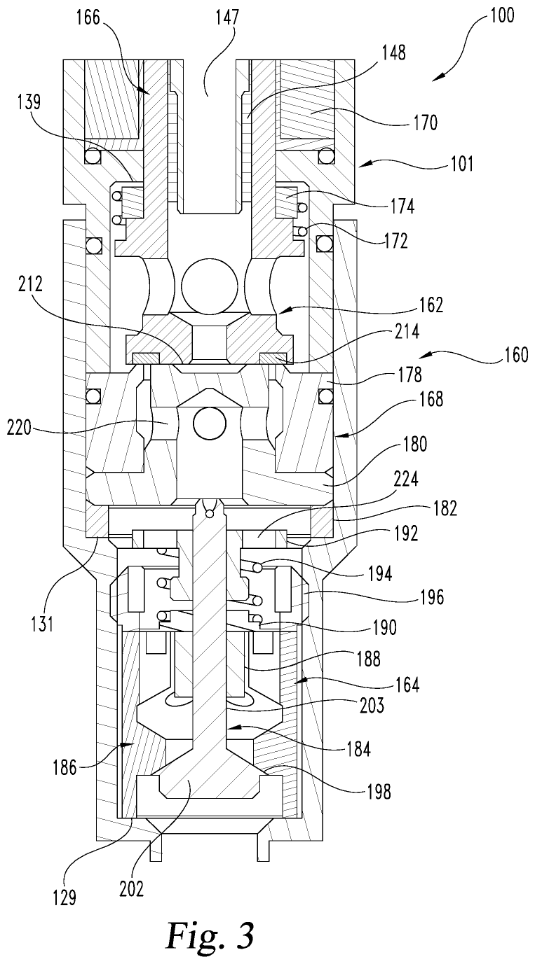

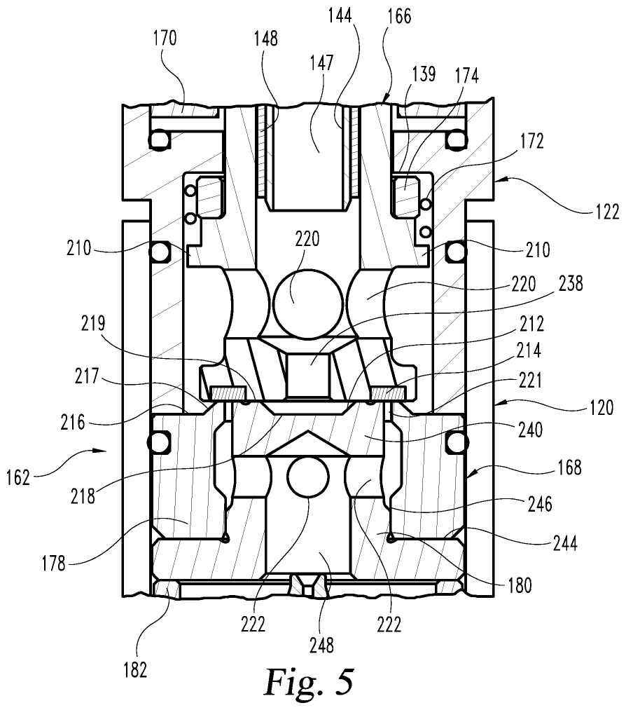

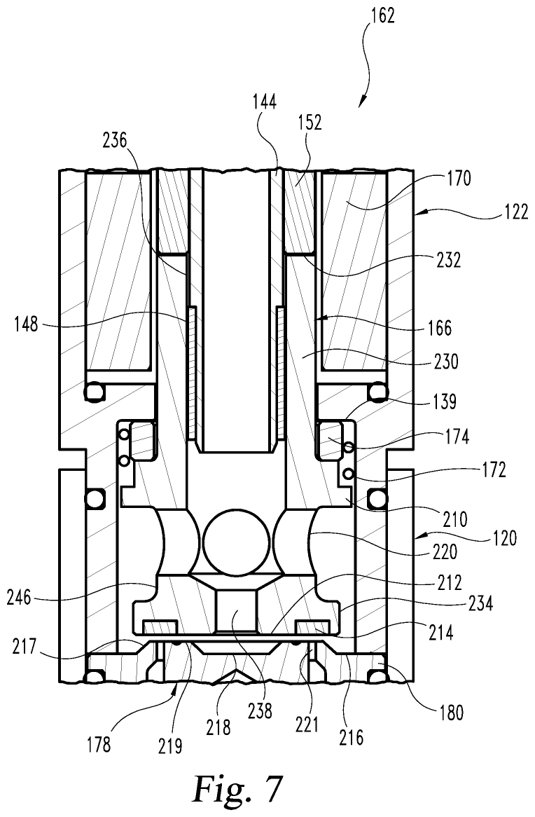

First plunger 166 is biased into sealing engagement with first valve seat 168 by a first valve spring 172. First valve spring 172 contacts a distally facing surface 139 located within interior 137 of transition part 122 adjacent to insert region 134. First valve spring 172 also contacts a proximal side of plunger flange 210 of first plunger 166. A buffer 174 is also provide between the distally facing surface 139 of transition part 122 of insert region 134 and plunger flange 210. Buffer 174 can be used to control the amount of axial movement of first plunger 166 in response to actuation by actuator 170. For example, when first valve 162 is closed, buffer 174 does not occupy the entire space between plunger flange 210 and distally facing surface 139, such as shown in FIGS. 3 and 5. When first valve 162 is opened as shown in FIG. 7, first valve spring 172 compresses and the first plunger 166 translates axially in the proximal direction until buffer 174 contacts each of plunger flange 210 and distally facing surface 139 to limit or prevent further axial displacement of first plunger 166 in the proximal direction.

First valve seat 168 includes an outer seat member 178 and an inner seat member 180 located in interior 133 of outlet part 120. Outer seat member 178 is sealingly engaged in third stepped region 132 with seat seal 179. Inner seat member 180 is located within outer seat member 178. Inner seat member 180 is supported by a spacer 182 on a proximally facing lip 131 between second stepped region 130 and third stepped region 132 of outlet part 120. The distal end of insert region 134 of transition part 122 may also contact the proximal side of first valve seat 168 to axially secure valve seat in injector body 101. In the illustrated embodiment, first valve seat 168 is comprised of two separate members, but could also be composed of a single member.

Second valve 164 includes second valve seat 186 supported on the proximally facing lip 129 between first stepped region 128 and second stepped region 130. A stopper 196 is engaged to outlet part 120 in stepped region 130 to secure second valve seat 186 against lip 129. Second valve seat 186 includes a cylindrical body having an inner bore 197 with a seat portion 198 projecting into inner bore 197. Second plunger 184 includes a head 202 that contacts seat portion 198 in the closed position of second valve 164, and head 202 is moved distally away from seat portion 198 to open second valve 164.

Second plunger 184 includes a stem 203 extending axially from head 202 through inner bore 197 toward first valve 162. Stem 203 includes a guide bushing 188 extending therearound. Other embodiments contemplate guide bushing 188 is omitted and plunger 184 is guided by second valve seat 186. A plunger stop 190 is positioned on top of valve seat 186 around stem 203. Guide bushing 188 is axially fixedly within second valve seat 186, and stem 203 can move axially relative to guide bushing 188 and plunger stop 190.

The proximal end of stem 203 of second plunger 184 is coupled to a collar 192, such as with a press fit or other fixed attachment, and collar 192 sets the stroke of second plunger 184. Collar 192 is biased proximally by a second valve spring 194 between collar 192 and plunger stop 190 so that head 202 of second plunger 184 is normally biased against seat 198. In an embodiment, head 202 and seat 198 are both made of metal material that is capable of withstanding temperatures produced by the combustion gases flowing from the combustion chamber into fuel passage 102. The metal-to-metal interface need not provide a seal that prevents all leakage of combustion gases through second valve 164, but is sufficient to limit exposure of first valve 162 to combustion temperatures.

Since second valve 164 is passively controlled by second valve spring 194 based on whether or not there is gaseous fuel flow through first valve 162, and since second valve 164 is not actuated by actuator 170 or connected to any components of first valve 162, the axial location of second valve 164 within injector body 101 can be optimized to balance temperature and gas mixing conditions for first valve 162 and second valve 164 during operation of fuel injector 100 depending on combustion conditions expected for the fuel, combustion parameters, etc.

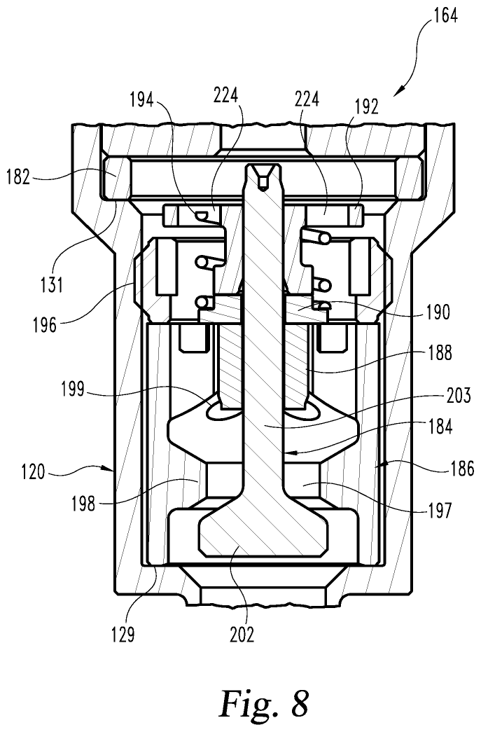

In response to gaseous flow being introduced from first valve 162, second valve spring 194 compresses due forces acting on collar 192 and head 202, which cause second plunger 184 to be displaced distally to an open position, as shown in FIG. 8. Stem 202 moves axially through guide bushing 188 until collar 192 contacts plunger stop 190, limiting the amount of distal displacement of second plunger 184. In the open position, head 202 is spaced distally from seat portion 198 to form a gap or passage for gaseous fuel flow to the combustion chamber 14.

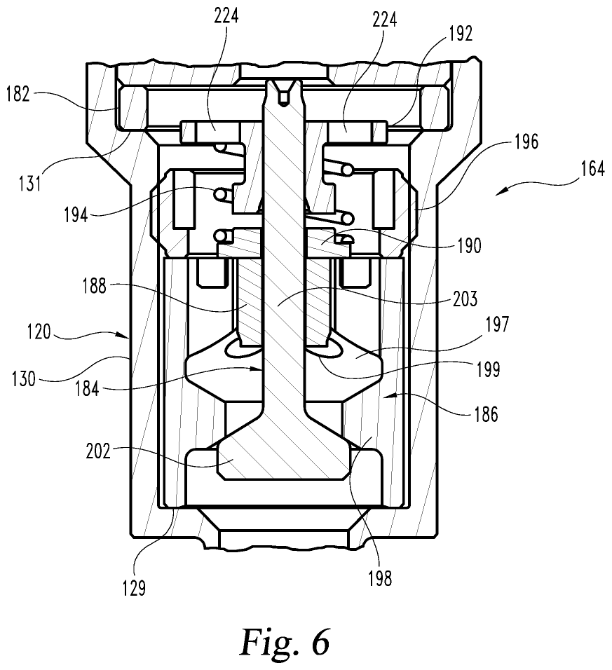

During operation of fuel injector 100, gaseous fuel enters fuel passage 102 at gas inlet end 104. The gaseous fuel is prevented from flowing through fuel passage 102 by the first valve 162 of valve assembly 160 being in a closed position by first valve spring 172, as shown in FIG. 5. In addition, second valve 164 of valve assembly 160 is normally closed by second valve spring 194 so that combustion gases cannot flow into fuel passage 102 to reach first valve 162, as shown in FIG. 6.

As discussed above, first valve spring 172 biases the first plunger 166 distally into contact with the first valve seat 168. First plunger 166 includes an end face 212 that sealingly contacts the first valve seat 168 with the first valve 162 in the closed position. The end face 212 including an elastomeric sealing member 214 that is engaged at two locations by the axial protrusions 217, 219 of first valve seat 168 in the closed position of the first valve 162. Sealing member 214 can be, for example, a ring-shaped sealing member that is embedded or inset into a recess in end face 212 of plunger 166.

In the illustrated embodiment, outer seat member 178 includes an outer inlet end 216 with an axial protrusion 217 in sealing contact with the sealing member 214. In addition, inner seat member 180 includes an inner inlet end 218 with an axial protrusion 219 in sealing contact with the sealing member 214 at a second location that is separate from the first location. In an embodiment, the axial protrusion 217 on outer inlet end 216 and the axial protrusion 219 on inner inlet end 218 form concentric circles that contact sealing member 214 at two different radial locations around the annular sealing member 214. A seat passage 221 is formed between axial protrusions 217, 219 since the inner inlet end 218 of inner seat member 180 is spaced radially inwardly from the outer inlet end 216 of outer seat member 178. In an embodiment, seat passage 221 is a single, annular passage between outer seat member 178 and inner seat member 180. In other embodiments, seat passage 221 is comprised of multiple passages between outer seat member 178 and inner seat member 180.

When first valve 162 is opened, gaseous fuel flow is admitted into the seat passage 221 between the outer inlet end 216 and the inner inlet end 218 due to sealing member 214 of first plunger 166 breaking contact with the axial protrusions 217, 219 of outer seat member 178 and inner seat member 180, as shown in FIG. 7. With first valve 162 open, the gaseous fuel flows out of first plunger 166 through plunger sidewall outlets 220, and around the distal second end 234 of plunger 166 and between end face 212 of first plunger 166 and outer inlet end 216 of outer seat member 178, then through the passage 221 between outer inlet end 216 of outer seat member 178 and inner inlet end 218 of inner seat member 180. The gaseous fuel enters inner seat member 180 through a plurality of sidewall inlets 222 of inner seat member 180. The gaseous fuel then flows around collar 192 and/or through the optional axial bores 224 defined by collar 192 of second valve 164 into second valve 164.

The gaseous fuel pressure acting on head 202 of second plunger 184 compresses second valve spring 192 and distally displaces second plunger 184 to disengage it from seat portion 198, opening second valve 164 as shown in FIG. 8. The amount of distal displacement of second plunger 184 is limited by collar 192 contacting the plunger stop 190 in second valve seat 186. Gaseous fuel flows through one or more axial seat bores 199 formed through second valve seat 186 that open into inner bore 197.

When gaseous fuel flow is terminated, the actuator 170 is deactivated and first valve spring 172 returns first plunger 166 into sealing engagement with first valve seat 168. The termination of gaseous fuel flow also allows second valve spring 194 to return second plunger 184 into engagement with second valve seat 186. In the closed position, the second valve 164 prevents, or substantially prevents, combustion gases from reaching first valve 162. As a result, first valve 162 is subject to less severe temperature and pressure changes than would be created if second valve 164 were omitted.

In an embodiment the first plunger 166 includes an elongated cylindrical plunger body 230 axially extending from a first end 232 to an opposite second end 234. The first end 232 is engaged to actuator 170, and actuator 170 is operable to move the first plunger 166 axially toward and away from the first valve seat 168. The second end 234 includes end face 212 with sealing member 214 that sealingly contacts the first valve seat 168 while the first valve 162 is in the closed position.

In an embodiment, the elongated body 230 of the first plunger 166 includes an axial passage 236 that opens at the proximal first end 232 of the first plunger 166 for receiving tube 144 and gaseous fuel flow. Plunger body 230 also includes a chamber 238 at the distal second end 234 of the first plunger 166 that is adjacent to the end face 212. Axial passage 236 opens into chamber 238, chamber 238 opens through end face 212, and sealing member 214 extends around the opening of chamber 238 in end face 212. A plurality of sidewall outlets 220 are distributed around the chamber 238 to allow gaseous fuel flow trans-axially out of the chamber 238, around an exterior of the elongated body 230, and between end face 212 and the first valve seat 168 when the end face 212 is spaced from the first valve seat 168. Gas flow though the opening of chamber 238 at end face 212 may also occur.

In an embodiment, first valve seat 168 includes an inner seat member 180 having a cylindrical body 240 extending from inner inlet end 218 to an opposite flanged second end 244. The inner inlet end 218 includes axial protrusion 219 that contacts the end face 212 of the first plunger 166 in the closed position of the first valve 162. The first cylindrical body 240 includes a first sidewall 246 extending between the inner inlet end 218 and the flanged second end 244. The first sidewall 246 extends around an inner bore 248 of the cylindrical body 240, and the inner bore 248 is closed at the inner inlet end 218 of the first cylindrical body 240, and is axially open at the flanged second end 244 of the cylindrical body 240.

The cylindrical body 240 includes a plurality of sidewall inlets 222 distributed around the first sidewall 246. The plurality of sidewall inlets 222 admit gaseous fuel flow from the open first valve 162 that flows into seat passage 221, through sidewall inlets 222, and into the inner bore 248 of the first cylindrical body 240. The second valve seat 186 of the second valve 164 includes an axial inner bore 197 to receive gaseous fuel flow from the inner bore 248 of the first valve seat 168 through axial seat bores 199. The gaseous fuel flow received from the inner bore 248 of the first valve seat 168 into the second valve seat 186 displaces the second plunger 184 from the second valve seat 186 to open second valve 164. When first valve 162 is closed, the second valve spring 194 automatically closes second valve 164 to isolate combustion gases in fuel passage 102 distally of second valve 164.

Further written description of a number of example embodiments shall now be provided. According to one aspect, a fuel injector for providing gaseous fuel to a combustion chamber is provided. The fuel injector includes an elongated injector body defining a longitudinally extending fuel passage therein, the fuel passage extending from a gas inlet end to a gas outlet end of the injector body. The fuel injector also includes a valve assembly in the fuel passage. The valve assembly includes a first valve that is selectively opened and closed to control gaseous fuel flow through the fuel passage to the combustion chamber, and a second valve configured to control combustion gas flow from the combustion chamber into the fuel passage through the gas outlet end. The second valve is spaced longitudinally from the first valve toward the gas outlet end, the second valve is biased to a closed position, and the second valve is moved from the closed position to an open position by the gaseous fuel flow through the opened first valve.

In an embodiment, the fuel injector includes a nozzle on the gas outlet end of the injector body, wherein the nozzle is configured to divert gaseous fuel flow through the gas outlet end into the combustion chamber.

In an embodiment, the first valve includes a first valve seat in the fuel passage, and the first valve seat supported in the injector body. The first valve also includes a first plunger biased into contact with the first valve seat to close the first valve, and an actuator that is actuated to lift the first plunger from the first valve seat to open the first valve.

In an embodiment, the actuator is a solenoid coupled to the first plunger. In an embodiment, the first valve includes a first valve spring that biases the first plunger into contact with the first valve seat.

In an embodiment, the first plunger includes an end face that contacts the first valve seat with the first valve in the closed position, and the end face includes an elastomeric sealing member that is engaged by the first valve seat in the closed position of the first valve.

In an embodiment, the first valve seat includes an outer seat member, and the outer seat member includes an outer inlet end in contact with the sealing member. The first valve seat also includes an inner seat member located at least partially within the outer seat member. The inner seat member includes an inner inlet end in contact with the sealing member. The inner inlet end is spaced inwardly from the outer inlet end to admit gaseous fuel flow from around the first plunger into the space between the outer inlet end and the inner inlet end in response to the first plunger being lifted from the first valve seat to open the first valve.

In an embodiment, the second valve includes a second valve seat in the fuel passage. The second valve seat is supported by the injector body. The second valve also includes a second plunger biased into contact with the second valve seat to close the second valve.

In an embodiment, the second valve includes a valve spring that biases the second plunger into contact with the second valve seat.

In an embodiment, the second plunger includes a head at one end thereof and a stem extending from the head, and the head and the second valve seat contacted by the head with the second valve in the closed position are both metal.

In an embodiment, the first plunger of the first valve includes an elastomeric sealing member that contacts the first seat of the first valve with the first valve in the closed position.

In an embodiment, the first plunger of the first valve is displaced toward the gas inlet end to open the first valve. The second plunger of the second valve is displaced toward the gas outlet end to open the second valve.

According to another aspect of the present disclosure, a valve assembly in an axially extending gaseous fuel passage of a fuel injector provides gaseous fuel to a combustion chamber. The valve assembly includes a first valve in the gaseous fuel passage and a second valve in the gaseous fuel passage. The first valve includes a first valve seat and a first plunger. The first plunger is actuatable between an open position in which the first plunger is axially spaced from the first valve seat and a closed position in which the first plunger is in sealing contact with the first valve seat. The second valve is axially spaced from the first valve along the gaseous fuel passage. The second valve includes a second valve seat and a second plunger biased into engagement with the second valve seat. The second plunger is disengaged from the second valve seat by gaseous fuel flow through the first valve when the first valve is in the open position.

In an embodiment, the second plunger moves axially away from the first valve in order to disengage from the second valve seat. In an embodiment, the first plunger moves axially away from the second valve when actuated to the open position.

In an embodiment, the second plunger automatically engages the second valve seat to close the second valve in response to the gaseous fuel flow through the first valve being shut off.

In an embodiment, the first valve includes an electronic actuator operable to actuate the first plunger between the open position and the closed position. The second plunger is not moved by the electronic actuator.

In an embodiment, the first plunger includes an elongated body axially extending from a first end to an opposite second end. The first end is engaged to an actuator operable to move the first plunger axially toward and away from the first valve seat. The second end includes an end face with a seal that sealingly contacts the first valve seat while the first valve is in the closed position.

In an embodiment, the elongated body of the first plunger includes an axial opening at the first end of the first plunger for receiving gaseous fuel flow, and a chamber at the second end of the first plunger adjacent to the end face of the first plunger. The first plunger also includes a plurality of sidewall outlets around the chamber to allow gaseous fuel flow trans-axially out of the chamber, around an exterior of the elongated body, and between end face and the first valve seat when the end face is spaced from the first valve seat.

In an embodiment, the first valve seat includes a first cylindrical body having a first end and an opposite second end. The first end contacts the end face of the first plunger in the closed position of the first valve. The first cylindrical body includes a first sidewall extending between the first end and the second end of the first cylindrical body. The first sidewall extends around an inner bore of the first cylindrical body, and the inner bore being closed at the first end of the first cylindrical body and open at the second end of the first cylindrical body. The cylindrical body includes a plurality of sidewall inlets distributed around the cylindrical body. The plurality of sidewall inlets admit gaseous fuel flow from the open first valve into the inner bore of the first cylindrical body. The second valve seat of the second valve includes an axial bore to receive gaseous fuel flow from the inner bore of the first valve seat. The gaseous fuel flow received from the inner bore of the first valve seat into the second valve seat displaces the second plunger from the second valve seat.

While illustrative embodiments of the disclosure have been illustrated and described in detail in the drawings and foregoing description, the same is to be considered as illustrative and not restrictive in character, it being understood that only certain exemplary embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A fuel injector for providing gaseous fuel to a combustion chamber, the fuel injector comprising:
an elongated injector body defining a longitudinally extending fuel passage therein, the fuel passage extending from a gas inlet end to a gas outlet end of the injector body;
a valve assembly in the fuel passage, the valve assembly including:
a first valve that is selectively opened and closed to control gaseous fuel flow through the fuel passage to the combustion chamber; and
a second valve configured to control combustion gas flow from the combustion chamber into the fuel passage through the gas outlet end, wherein:
the second valve is spaced longitudinally from the first valve toward the gas outlet end;
the second valve is biased to a closed position; and
the second valve is moved from the closed position to an open position by the gaseous fuel flow through the opened first valve.

2. The fuel injector of claim 1, further comprising a nozzle on the gas outlet end of the injector body, wherein the nozzle is configured to divert gaseous fuel flow through the gas outlet end into the combustion chamber.

3. The fuel injector of claim 1, wherein the first valve includes:
a first valve seat in the fuel passage, the first valve seat supported in the injector body;
a first plunger biased into contact with the first valve seat to close the first valve; and
an actuator that is actuated to lift the first plunger from the first valve seat to open the first valve.

4. The fuel injector of claim 3, wherein the actuator is a solenoid coupled to the first plunger.

5. The fuel injector of claim 3, further comprising a first valve spring that biases the first plunger into contact with the first valve seat.

6. The fuel injector of claim 3, wherein the first plunger includes an end face that contacts the first valve seat with the first valve in the closed position, the end face including an elastomeric sealing member that is engaged by the first valve seat in the closed position of the first valve.

7. The fuel injector of claim 6, wherein the first valve seat includes:
an outer seat member, the outer seat member including an outer inlet end in contact with the sealing member; and
an inner seat member located at least partially within the outer seat member, the inner seat member including an inner inlet end in contact with the sealing member, wherein the inner inlet end is spaced inwardly from the outer inlet end to admit gaseous fuel flow from around the first plunger into the space between the outer inlet end and the inner inlet end in response to the first plunger being lifted from the first valve seat to open the first valve.

8. The fuel injector of claim 3, wherein the second valve includes:
a second valve seat in the fuel passage, wherein the second valve seat is supported by the injector body; and
a second plunger biased into contact with the second valve seat to close the second valve.

9. The fuel injector of claim 8, further comprising a valve spring that biases the second plunger into contact with the second valve seat.

10. The fuel injector of claim 8, wherein the second plunger includes a head at one end thereof and a stem extending from the head, and the head and the second valve seat contacted by the head with the second valve in the closed position are both metal.

11. The fuel injector of claim 10, wherein the first plunger of the first valve includes an elastomeric sealing member that contacts the first seat of the first valve with the first valve in the closed position.

12. The fuel injector of claim 8, wherein:
the first plunger of the first valve is displaced toward the gas inlet end to open the first valve; and
the second plunger of the second valve is displaced toward the gas outlet end to open the second valve.

13. A valve assembly in an axially extending gaseous fuel passage of a fuel injector for providing gaseous fuel to a combustion chamber, the valve assembly comprising:
a first valve in the gaseous fuel passage, the first valve including a first valve seat and a first plunger, wherein the first plunger is actuatable between an open position in which the first plunger is axially spaced from the first valve seat and a closed position in which the first plunger is in sealing contact with the first valve seat; and
a second valve in the gaseous fuel passage, the second valve axially spaced from the first valve along the gaseous fuel passage, the second valve including a second valve seat and a second plunger biased into engagement with the second valve seat, wherein the second plunger is disengaged from the second valve seat by gaseous fuel flow through the first valve when the first valve is in the open position.

14. The valve assembly of claim 13, wherein the second plunger moves axially away from the first valve in order to disengage from the second valve seat.

15. The valve assembly of claim 14, wherein the first plunger moves axially away from the second valve when actuated to the open position.

16. The valve assembly of claim 13, wherein the second plunger automatically engages the second valve seat to close the second valve in response to the gaseous fuel flow through the first valve being shut off.

17. The valve assembly of claim 13, wherein:
the first valve includes an electronic actuator operable to actuate the first plunger between the open position and the closed position; and
the second plunger is not moved by the electronic actuator.

18. The valve assembly of claim 13, wherein the first plunger includes:
an elongated body axially extending from a first end to an opposite second end;
the first end is engaged to an actuator operable to move the first plunger axially toward and away from the first valve seat; and
the second end includes an end face with a seal that sealingly contacts the first valve seat while the first valve is in the closed position.

19. The valve assembly of claim 18, wherein the elongated body of the first plunger includes:
an axial opening at the first end of the first plunger for receiving gaseous fuel flow;
a chamber at the second end of the first plunger adjacent to the end face of the first plunger; and
a plurality of sidewall outlets around the chamber to allow gaseous fuel flow trans-axially out of the chamber, around an exterior of the elongated body, and between end face and the first valve seat when the end face is spaced from the first valve seat.

20. The valve assembly of claim 19, wherein the first valve seat includes:
a first cylindrical body having a first end and an opposite second end, the first end contacting the end face of the first plunger in the closed position of the first valve;
the first cylindrical body including a first sidewall extending between the first end and the second end of the first cylindrical body, the first sidewall extending around an inner bore of the first cylindrical body, the inner bore being closed at the first end of the first cylindrical body and open at the second end of the first cylindrical body;
the cylindrical body including a plurality of sidewall inlets distributed around the cylindrical body, the plurality of sidewall inlets admitting gaseous fuel flow from the open first valve into the inner bore of the first cylindrical body; and
the second valve seat of the second valve includes an axial bore to receive gaseous fuel flow from the inner bore of the first valve seat, the gaseous fuel flow received from the inner bore of the first valve seat into the second valve seat displacing the second plunger from the second valve seat.
